(19) United States
(12) Patent Application Publication
(10) Pub. No.: US 2005/0279905 A1
(43) Pub. Date: Dec. 22, 2005

(54) Air movement device with a quick assembly base

(75) Inventors: Andrew J. Parker, Novato, CA (US); Mark H. Duncan, San Francisco, CA (US)

Correspondence Address: BELL, BOYD & LLOYD LLC, P.O. BOX 1135, CHICAGO, IL, 60690-1135, US

(73) Assignee: Sharper Image Corporation, San Francisco, CA (US)

(21) Appl. No.: 11/003,058

(22) Filed: Dec. 3, 2004

Related U.S. Application Data
(60) Provisional application No. 60/563,388, filed on Apr. 19, 2004.
(60) Provisional application No. 60/545,717, filed on Feb. 18, 2004.

(51) Int. Cl. B23C 1/20; A47G 29/00

(52) U.S. Cl. 248/346.01

(57) ABSTRACT

A removable quick assembly base configured to be coupled to an air movement apparatus. The base comprises a first post component and a second post component adapted to coupled to one another to form a post. The base includes a first base component and a second base component adapted to be coupled to one another to form a base, whereby the base is coupled to the post. The base includes a collar for securing the first and second base components to the post, wherein the collar is removably coupled to the post. The collar is positioned beneath the first and second base components when coupled to the post. The collar is preferably circular and has a threaded interior surface configured to couple to a threaded portion of the post. The base further comprises one or more attachments for retaining a cord, whereby the attachments are located under the base.

### CLAIM OF PRIORITY

This Patent Application claims priority under 35 U.S.C. 119(e) to the co-pending U.S. Provisional Patent Application Ser. No. 60/563,388 entitled, “AN AIR MOVEMENT DEVICE WITH A QUICK ASSEMBLY BASE” by Andrew Parker et al., filed Apr. 19, 2004 (Attorney Docket No. SHPR-01410US1) and Provisional Patent Application Ser. No. 60/545,717 entitled, “AN AIR MOVEMENT DEVICE WITH A QUICK ASSEMBLY BASE” by Andrew Parker et al., filed Feb. 18, 2004 (Attorney Docket No. SHPR-01410US0), both of which are hereby incorporated by reference.

### FIELD OF THE INVENTION

The present invention relates generally to a base and in particular, to a removable base assembly for an upstanding air movement device.

### BACKGROUND OF THE INVENTION

Many types of fans exist in the market today. The fans range from small desktop models to large, vertical standing models. In particular, large upright fans require a relatively large base to support the fan. Many fans include the large base permanently attached to the fan housing and are therefore inseparable from the base. This poses a problem in packaging the fan, because the size of the packaging must be large enough to accommodate a large base. This results in an unnecessary amount of resources and materials used to package the fan. In addition, the large base makes it difficult for the user to transport the fan or store the fan in closets and other narrow places due to the large size of the base.

What is needed is a base for an air movement device which can be easily assembled and disassembled to allow the device to be easily packaged and/or easily stored in relatively narrow spaces.

### BRIEF DESCRIPTION OF THE FIGURES

FIG. 1A illustrates an exploded view of the air movement device with the quick assembly base in accordance with the present invention.

FIG. 1B illustrates an exploded view of the quick assembly base in accordance with the present invention.

FIG. 2 illustrates a perspective view of the air movement device with the assembled base in accordance with the present invention.

FIG. 3A-3C illustrate schematics of the method of assembling and disassembling the present base in accordance with the present invention.

### DETAILED DESCRIPTION OF THE PRESENT INVENTION

Embodiments of the present invention are directed to an air movement device with a quick assembly base that is used to support the device which can be a fan, humidifier, heater, air cleaner or other household or commercial device. It is contemplated by one skilled in the art that the present removable base 100 is utilized with any air movement device, such as a cooler, fan, humidifier, heater or other device, such as The Ionic Breeze® manufactured by The Sharper Image®, Inc. However, for brevity, the present invention is described herein to be coupled to an upright air-blowing fan. It is understood that a wide range of upstanding devices for home and commercial use can benefit from the base of the present invention. For example, any upstanding structure such as a table can benefit from the base of the present invention. Other features and advantages of the present invention will become apparent after reviewing the detailed description of the preferred and alternative embodiments set forth below.

One aspect of the invention is directed to a quick assembly and removable base for an air movement apparatus which has a post. The base comprises a first base component which is adapted to be coupled to the post. The base also includes a second base component which is also adapted to be coupled to the post, whereby the second base component is configured to engage the first base component to form the base. The base includes a collar for securing the first and second base components to the post, wherein the collar is removably coupled to the post.

Another aspect of the present invention is directed to a quick assembly and removable base which is adapted to hold an upright air movement structure. The base comprises a plurality of post components which form a post and base components which are adapted to be coupled to the post. Each base component is configured to engage an adjacent base component. The plurality of engaged adjacent base components form the base, wherein the plurality of base components are disengageable from one another. The base includes a device for securing the engaged base components to the post, wherein the device is coupled to the post.

Yet another aspect of the present invention is directed to a quick assembly and removable base for an upright air movement system. The removable base is configured to be selectively assembled and disassembled to a partially threaded post of the system. The base comprises a first base half having a first cutout adapted to correspond with the post, whereby the first base half includes a first interface surface. The base comprises a second base half having a second cutout adapted to correspond with post. The second half includes a second interface surface, wherein the first base half and second base half are configured to form the base around the post when the first interface surface is in contact with the second interface surface. The base comprises a collar for securing the base to the post, wherein the collar is coupled to the post beneath the formed base.

Another aspect of the invention is directed to an air movement system comprising a housing and a vertical post coupled to the housing, wherein the post is positioned beneath the housing. The system includes a quick assembly and selectively removable base which further comprises a plurality of base components that are adapted to be coupled to the post. Each base component is configured to engage an adjacent base component such that the plurality of engaged adjacent base components together form the base. The selectively removable base further comprises a device for securing the base components to the post, wherein the device is coupled to the post.

For the above embodiments, the device or collar is preferably positioned beneath the first and second base components when it is coupled to the post. The removable base further comprises one or more attachments for retaining a cord that is coupled to the air movement system, whereby the attachment is coupled to an underside of the base.

In one embodiment, the first base component further comprises a first interface surface and a male mating feature located proximal to the first interface surface. In one embodiment, the second base component further comprises a second interface surface and a female mating feature located proximal to the second interface surface. The female mating feature engages the male mating feature to place the first interface surface and the second interface surface in contact with one another.

In one embodiment, the device or collar is circular and has a threaded interior surface configured to couple to a threaded portion of the post by a twisting motion. In each of the embodiments, it is preferred that the post is comprised of a plurality of post components which are coupled together to form the post. However, the post is alternatively one piece and is not made of a plurality post components coupled together to form the post.

Another aspect of the invention is directed to a method of assembling an air movement device. The method comprises the steps of providing a housing having a post, wherein the post has an outer surface. The method includes providing a first base component which has a first cutout that is adapted to correspond with the outer surface of the post, wherein the first base component includes a first interface surface. The method also includes providing a second base component which has a second cutout adapted to correspond with the outer surface of the post, whereby the second half includes a second interface surface. The method includes coupling the first base component with the second base component to form a base, wherein the first interface surface and the second interface surface are placed in contact with one another and the first cutout and the second cutout are in contact with the outer surface of the post.

The method further comprises the step of coupling a collar to the post, wherein the collar is positioned beneath the first and second base components and is configured to secure the coupled first and second base components to the post. The collar preferably has a threaded interior surface which is configured to correspond with a threaded portion of the post such that the collar is coupled to the post by a twisting motion. The method further comprises the step of coupling an attachment to the housing, wherein the attachment retains a power cord which is coupled to the housing and is located underneath the base. In one embodiment, the first base component further comprises a male mating feature located proximal to the first interface surface. In one embodiment, the second base component further comprises a female mating feature that is located proximal to the second interface surface, wherein the female mating feature is configured to engage the male mating feature.

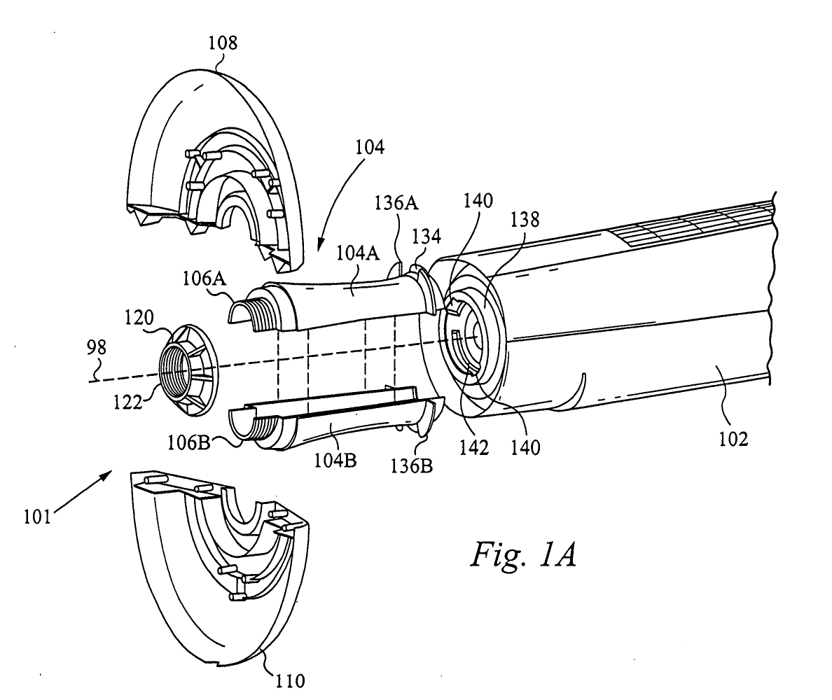

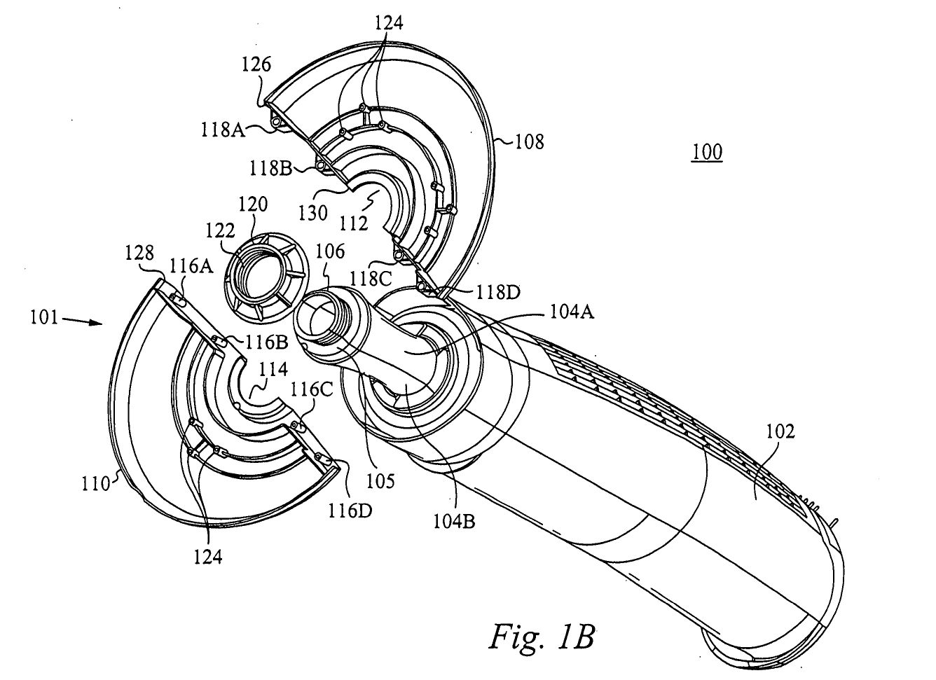

FIG. 1A illustrates an exploded view of the air movement device 100 with the quick assembly and removable base 101 in accordance with the present invention. In particular, the air movement device 100 includes a housing 102 and the quick assembly base 101. The base 101 preferably includes a post 104 having a two post components 104A and 104B. In addition, the air movement device 100 includes the base 101 which is coupled to the post 104 as well as a securing collar 120 which secures the base 101 to the post 104.

The post 104 is preferably adapted to be assembled and coupled to the body 102. In particular, the post 104 is preferably made of two post components 104A, 104B which are adapted to be coupled to one another. It should be noted that any number of post components 104A, 104B are contemplated to form the entire post 104. In another embodiment, the post 104 is one piece and is not formed of a plurality of components coupled together. In the preferred embodiment, each post component 104A, 104B has male and/or female engaging members which secure the post components 104A, 104B together by a snap fit. Alternatively, any other appropriate mechanism or method is utilized to couple and secure the components 104A, 104B together.

As shown in FIG. 1A, the post component 104A has two ends 106A and 136A, whereby the post component 104B, whereby end 106 has two ends 106B and 136B. The ends 106A, 106B include a threaded portion, and the ends 136A, 136B include a lipped portion. The threaded portions of the post components 104A and 104B are configured to form a seamless threaded portion which allows the collar 120 to be rotatably secured to the post 104 when the post components 104A and 104B are coupled to one another. The other end 136 of each post component 104A, 104B preferably includes a lip 134 which protrudes out circumferentially from the surface of the post 104. The lip 134 is designed to fit within the corresponding notch 140 in the bottom of the housing 102. As shown in FIG. 1A, the bottom of the housing includes a securing ring 138 which includes two notches 140. It should be noted that any number of notches 140 are contemplated, and the number of notches 140 corresponds to the number of lips 134 on the post 104. Once the lips 134 of the formed post 104 are fit into the corresponding notches 140 of the ring 138, the post 104 is secured to the housing 120 by rotating the post about the axis 98. By rotating the post 104 about axis 98, the lips 134 slide along one or more indented grooves 142 located on the inner surface of the ring 138. The grooves 142 preferably includes any appropriate locking feature (not shown) which locks the post 104 to the housing 102. The locking feature also preferably allows the user to easily remove the post 104 if desired. Thus, the grooves 142 and lock (not shown) secure the lips 134 to the ring 138 and prevent the post 104 from being disengaged from the housing 102.

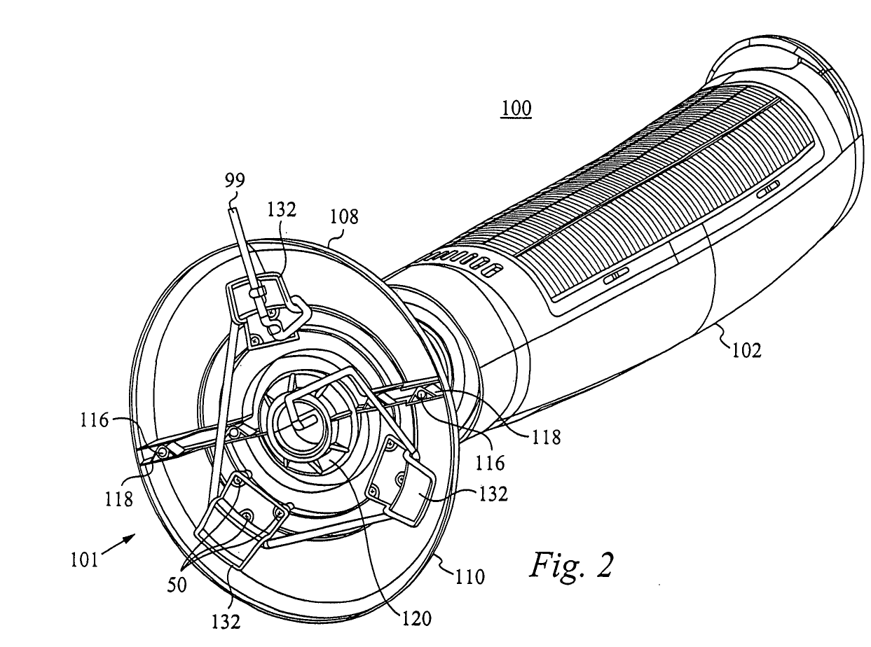

The base 101 shown in FIG. 1A preferably comprises a first half 108 and a second half 110. The base halves 108 and 110 are preferably coupled to one another and are then coupled to the post 104 to form the entire base 101 (FIG. 2). It should be noted that although the preferred embodiment is shown to have a circular base 101, it is contemplated by one skilled in the art that the base is alternatively any other appropriate shape (e.g., square, rectangular, trapezoidal). In addition, although there are two base components 108 and 110 shown in FIG. 1A, it is contemplated by one skilled in the art that any number of individual base components are alternatively used to form the entire base 101, irrespective of the shape of the entire base 101. For example, an assembly having a square base (not shown) has four base components, whereby each base component is engaged with an adjacent base component to form the entire base. It should be noted that the term adjacent is used herein to refer to base components coupled side to side with one another as well as two opposing base components, as in FIGS. 1 and 2, which, together, form the entire base 101.

Referring back to FIG. 1A, the base components 108 and 110 each preferably have a cutout portion. In particular, the base component 108 has a cutout 112, and the base component 110 has a cutout 114. The cutouts 112, 114 preferably have a dimension and a shape which correspond to the outer surface of the post 104. In the preferred embodiment shown in FIGS. 1 and 2, the cutouts 112, 114 form a circular aperture when the base components 108, 110 are coupled together to form the base 101. This is because the post 104 has a circular cross-section. In the preferred embodiment, each circular cutout 112, 114 has a radius slightly larger than the radius of the post 104 but smaller than the radius of the lip 105 above the threaded portion 106. The diameter of the circular aperture is such that the base 101 fits snug around the post 104 and is properly secured to the post 104 by the collar 120 (see below).

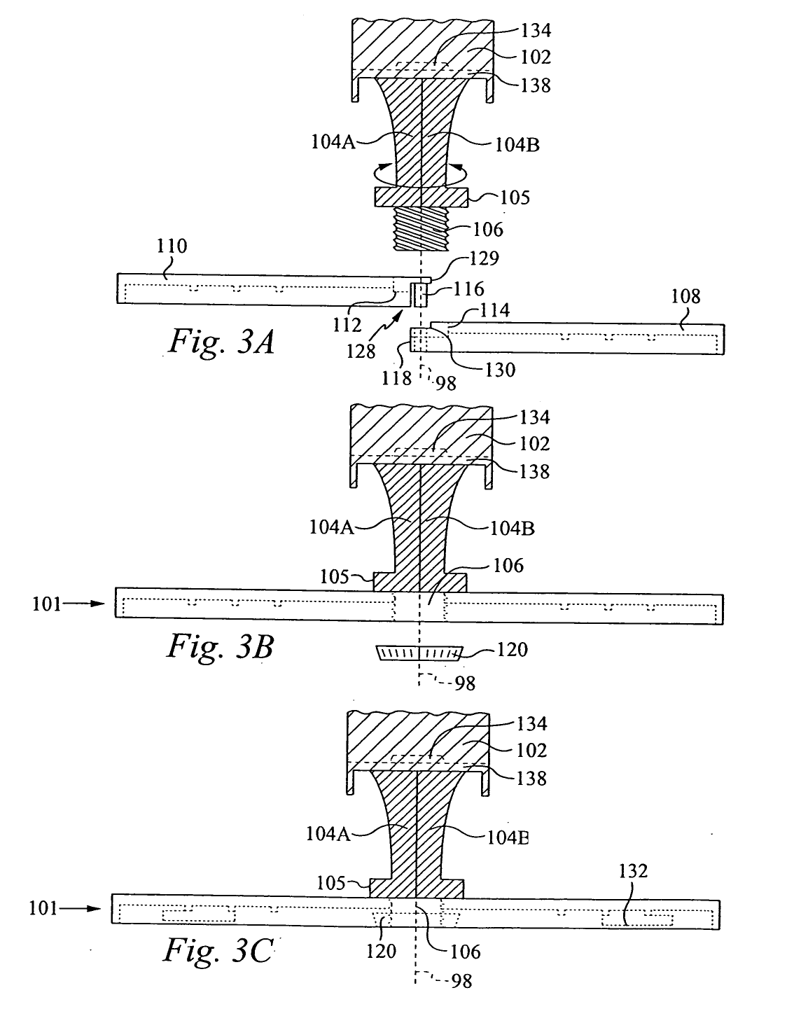

The base components 108 and 110 each also have an interface surface wherein each interface surface comes into contact with the interface surface(s) of the adjacent base component(s) to form the base 101. In particular, base component 108 includes the interface surface 130, whereas the base component 110 includes the interface surface 128. The interface surface 128 of the base component 106 preferably includes a lip 129 from which the male engaging members 116A-116D protrude. The lip 129 engages the corresponding indented region of the interface surface 130 (FIG. 3A) of the base component 108 when the male members 116A-116D are received by the female members 118A-118D to secure the base components 108, 110 together to form the base 101. In the preferred embodiment shown in FIGS. 1 and 2, the interface surface 130 is in contact with the interface surface 128 of the adjacent base component 110. Alternatively, for abase (not shown) comprising more than two base components (not shown), each base component has more than one interface surface. Therefore, each interface surface of each base component is in contact with the appropriate interface surface of the appropriate adjacent base component when the entire base 101 is formed.

The base components 108, 110 each preferably include interlocking coupling features which allow the components 108, 110 to be coupled to one another to form the entire base 101. As shown in FIGS. 1 and 2, the base component 110 includes several male engaging members, such as pins 116A-116D. In addition, the base component 108 includes a corresponding number of female receiving members, such as apertures 118A-118D. In particular, the base components 108, 110 of the preferred embodiment are coupled to one another by inserting the male engaging members 116A-116D in the corresponding female receiving members 118A-118D, respectfully, as shown in FIG. 2. The coupling features 116, 118 are configured at an appropriate position on each base component 108, 110 such that the interface surfaces 128 and 130 are in contact with each other when the engaging members 116A-116D are coupled to the receiving members 118A-118D, as shown in FIG. 2. It should be noted that although four coupling members 116, 118 are shown in FIGS. 1 and 2, it is apparent to one skilled in the art that any number of coupling members 116, 118 are alternatively utilized. Although the preferred embodiment utilizes male and female coupling features, it is apparent to one skilled in the art that any other appropriate type of coupling feature to couple the base components to each other is contemplated.

The present invention 100 preferably includes a securing device 120 which secures the entire base 101 to the post 104 so that the base 101 will not become unintentionally disengaged. The circular collar 120 has an aperture 122 extending there through, whereby the inner surface of the aperture 122 includes a series of threads which correspond to the threaded portion 106 of the post 104. In the preferred embodiment, the collar 120 is rotatably coupled to the threaded portion 106 of the post 104 by a twisting motion after the base 101 is coupled to the post 106. As shown in FIG. 1A, the circular collar 120 has several ribs on the outer surface to allow the user to grip and twist the collar 120. The collar 120 is preferably positioned underneath the base components 108 and 110 when coupled to the post 104. The base 101 is thereby securely coupled to the post due to the upward force applied by the collar 120 as well as the downward force applied by the lip 105 of the post 104. Although the securing device 120 is preferably a circular collar 120, the device 120 is alternatively any other shape which corresponds with the cross sectional shape of the post 104. In addition, although the collar 120 is preferably coupled to the post 104 by a twisting motion, it is contemplated by one skilled in the art that the device 120 is alternatively coupled to the post 104 by any other appropriate mechanism, means or method known in the art as long at the device 120 appropriately secures the base 101 to the post 104.

As shown in FIG. 2, the underside of the base components 108 and 110 preferably include a series of concentric ribs having a set of attachment members 132 coupled thereto. In particular, the ribs are shown to include sets of three apertures 124 (FIG. 1A) to which the attachment members 132 are coupled, preferably by a set of screws 50. In particular, as shown in FIG. 1A, the base component 110 includes one set of apertures 124, whereas base feature 108 has two sets of apertures 124. The attachment members 132 are preferably coupled to the underside of the base components 108 and 110 as shown in FIG. 2. The attachment members 132 are configured to retain the power cord 99 which extends from the housing 102 and/or post 104 and provides power to the fan. In the embodiment shown in FIG. 2, the power cord 99 extends from the post 104 downward through the aperture 122 of the collar 120. As shown in FIG. 2, the cord 99 is wrapped around the attachment members 132, whereby the members 132 retain the cord neatly underneath the fan 100. Although the attachment members 132 are shown coupled to the underside of the base components 108 and 110 by screws 50, it is apparent to one skilled in the art that the cord retaining attachments 132 are alternatively coupled to the base members 108 and 110 by any other appropriate means (e.g., snap fit, adhesive). In an alternative embodiment, the retaining members 132 are integrally formed with the base components 108, 110 as one piece and are not separably coupled thereto. It is also apparent to one skilled in the art that the attachments 132 are alternatively configured on the top surface of the base components 108, 110 or on a peripheral side surface of the base components 108, 110.

Assembly and disassembly of the present base will now be discussed in relation to FIGS. 3A-3C. FIGS. 3A-3C illustrate one method of assembling and disassembling the present base 101 in accordance with the present invention. In order to assemble the fan assembly 100 of the present invention, the user first couples the post components 104A and 104B together to form the entire post 104. As stated above, any appropriate method and mechanism is contemplated to couple the post components 104A, 104B together. The user then inserts the lips 134 of the formed post 104 into the corresponding notches 140 of the ring 138. Once the lips 134 are aligned with the grooves 142 within the ring 138, the user preferably rotates the post about the axis 98 until the post 104 is locked into position. The user FIGS. 3A-3C illustrates the post components 104A and 104B already coupled to one another and coupled to the securing ring 138.

The user preferably couples the base component 108 with the base component 110. In particular, the user aligns the base components 108, 110 such that each male engaging member 116A-116D is aligned with each corresponding female receiving members 118A-118D, respectively. The user then preferably inserts each male engaging member 116 into its appropriate corresponding female receiving member 118 and couples the base components 108, 110 to one another to form the entire base 101. As can be seen in FIG. 3A, the interface surface 128 of the base component 106 includes a lip 129 from which the male engaging members 116A-116D protrude. The lip 129 engages the corresponding indented interface surface 130 of the base component 108 when the male members 116A-116D are received by the female members 118A-118D to secure the base components 108, 110 together to form the base 101. As stated above, it is apparent that although the engaging members 116 and the receiving members 118 are shown and described, any other method or means of coupling the base components 108 and 110 are alternatively contemplated.

Once the entire base 101 is formed, the base 101 is coupled to the threaded portion 106 of the post 104. As discussed above, each base member 108, 110 preferably includes a cutout 112, 114 whereby the cutouts together form a shape, which corresponds to the cross sectional shape of the post 104. In the preferred embodiment, the cutouts together form a circular aperture which fits around the threaded portion 106. Therefore, as shown in FIGS. 3A and 3B, the base 101 is coupled to the post 104, whereby the threaded portion 106 is inserted through the circular aperture. Alternatively, the base members 108 and 110 are coupled to one another to form the base 101 after being coupled to the threaded portion 106 of the post 104. Once the base 101 is coupled to the threaded portion of the post 104, the securing device 120, preferably the collar, is coupled to the threaded portion 106, as shown in FIG. 3B. Preferably, the collar 120 is twisted or screwed onto the threaded portion 106 of the post 104 until the collar 120 comes into contact with and applies an upward force to the underside of the base 101. The collar 120 is preferably tightly secured underneath the base components 108 and 110 of the base 101, such that the base 101, once secured, does not jitter or rattle with respect to the post 104. In addition, the user couples the attachment members 132 to the underside of the base components 108, 110 either before or after the base 101 is coupled to the post 104.

The user is also able to freely disassemble the base 101 such that the fan 100 can be stored away or shipped. To disassemble the base 101, the user preferably unscrews the collar 120 from the threaded portion 106 of the post 104 (FIG. 3B). Once the collar 120 is removed, the user removes the base 101 from the threaded portion 106 and then decouples the base 101 into base components 108 and 110 (FIG. 3A). Alternatively, after the collar 120 is removed, the user is able to separate the base component 108 from the base component 110 without first removing the entire base 101 from the post 104. Preferably, the base 101 is disassembled by pressing the base component 108 in a downward motion and/or pulling the base component 110 in an upward motion, such that the male engaging features 116A-116D are disengaged from the female receiving features 118A-118D.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A selectively assembleable and removable base for an up-right apparatus comprising:
a. a post adapted to be coupled to the apparatus;
b. a first base component capable of being coupled to the post;
c. a second base component capable of being coupled to the post, the second base component configured to engage the first base component to form the base; and
d. a collar capable of securing the coupled first and second base components to the post.

2. The base according to claim 1 wherein the collar is positioned beneath the first and second base components when coupled to the post.

3. The base according to claim 1 further comprising an attachment for retaining a cord coupled to the apparatus, the attachment coupled to an underside of the base.

4. The base according to claim 1 wherein the first base component further comprises a first interface surface and a male mating feature.

5. The base according to claim 4 wherein the second base component further comprises a second interface surface and a female mating feature, the female mating feature configured to engage the male mating feature to place the first interface surface and the second interface surface in contact with one another.

6. The base according to claim 1 wherein the collar has a threaded interior surface adapted to couple to a threaded portion of the post, wherein the collar is coupled to the post by a twisting motion.

7. The base according to claim 1 wherein the post further comprises:
a. a first post component; and
b. a second post component selectively coupled to the first post component to form the post.

8. The base according to claim 1 wherein the post is removably coupled to the apparatus.

9. The base according to claim 1 wherein the post is rotatably coupled to the apparatus.

10. The base according to claim 1 wherein the post is selectively locked to the apparatus when coupled thereto.

11. A selectively assembleable and removable base adapted to support a structure, the base comprising:
a. a plurality of post components configured to be coupled to one another to form a post, wherein the post is adapted to be coupled to the structure;
b. a plurality of interlocking base components configured to be coupled to the post, each base component configured to engage an adjacent base component such that the plurality of engaged base components form the base, wherein the plurality of base components are disengageable from one another; and
c. a device configured to secure the engaged base components to the post when the device is coupled to the post.

12. The base according to claim 11 wherein the device is positioned beneath the structure.

13. The base according to claim 11 wherein the post is removably coupled to the structure.

14. The base according to claim 11 wherein the device is rotatably coupled to the structure.

15. The base according to claim 11 wherein the post is selectively locked to the structure when coupled thereto.

16. The base according to claim 11 further comprising a plurality of attachments for retaining a cord coupled to the structure, wherein the attachments are coupled to an underside of the base components.

17. The base according to claim 11 wherein a first base component in the plurality further comprises a first interface surface and a male mating feature.

18. The base according to claim 17 wherein a second base component in the plurality further comprises a second interface surface and a female mating feature, the female mating feature configured to engage with the male mating feature to place the first interface surface and the second interface surface in contact with one another.

19. The base according to claim 11 wherein the device is circular and has a threaded interior surface configured to couple to a threaded portion of a post externally from the structure and wherein the device is coupled to the post by a twisting motion.

20. An upright air movement device comprising:
a. an upright air movement device housing;
b. a post coupled to the air movement device housing;
c. a first base half having a first cutout configured to correspond with the post, the first base half including a first interface surface;
d. a second base half having a second cutout configured to correspond with post, the second half including a second interface surface, wherein the first base half and second base half form the base around the post when the first interface surface is in contact with the second interface surface; and
e. a collar configured to secure the base to the post, wherein the collar is coupled to the post beneath the formed base.

21. The system according to claim 20 further comprising an attachment for retaining a cord coupled to the air movement system, wherein the attachment is coupled to an underside of the base.

22. The system according to claim 20 wherein the first base half further comprises a male mating feature.

23. The system according to claim 22 wherein the second base half further comprises a female mating feature, the female mating feature configured to engage with the male mating feature.

24. The system according to claim 20 wherein the collar has a threaded interior surface configured to correspond with the threaded post such that the collar is coupled to the post by a twisting motion.

25. The system according to claim 20 wherein the post further comprises:
a. a first post component; and
b. a second post component selectively coupled to the first post component to form the post.

26. The system according to claim 20 wherein the post is removably coupled to the device.

27. The system according to claim 20 wherein the post is rotatably coupled to the device.

28. The system according to claim 20 wherein the post is selectively locked to the device when coupled thereto.

29. An air movement system comprising:
a. an air movement device having a housing;
b. a post coupled to the housing, wherein the post is positioned beneath the housing; and
c. a base further comprising:
i. a plurality of base components adapted to be coupled to the post, wherein each base component is configured to engage an adjacent base component such that the plurality of engaged base components together form the base; and
ii. a device to releaseably secure the base components to the post, wherein the device is coupled to the post.

30. The air movement system according to claim 29 wherein the device is positioned beneath the engaged base components.

31. The air movement system according to claim 29 further comprising a plurality of attachments for retaining a power cord coupled to the housing, wherein the attachments are coupled to an underside of the base components.

32. The air movement system according to claim 29 wherein a first base component in the plurality further comprises a first interface surface and a male mating feature.

33. The air movement system according to claim 32 wherein a second base component in the plurality further comprises a second interface surface and a female mating feature, the female mating feature configured to engage the male mating feature such that the first interface surface and the second interface surface are placed in contact with one another.

34. The air movement system according to claim 29 wherein the device is circular and has a threaded interior configured to correspond with a threaded portion of the post such that the device is coupled to the post by a twisting motion.

35. The air movement system according to claim 29 wherein the post further comprises:
a. a first post component; and
b. a second post component selectively coupled to the first post component to form the post.

36. The air movement system according to claim 29 wherein the post is removably coupled to the housing.

37. The air movement system according to claim 29 wherein the post is rotatably coupled to the housing.
